(19) United States
(12) Patent Application Publication
(10) Pub. No.: US 2015/0102605 A1
(43) Pub. Date: Apr. 16, 2015

(54) GENERATOR FOR A GEARLESS WIND POWER INSTALLATION

(71) Applicant: Wojciech Giengiel, Aurich (DE)

(72) Inventor: Wojciech Giengiel, Aurich (DE)

(73) Assignee: Wobben Properties GmbH, Aurich (DE)

(21) Appl. No.: 14/401,084

(22) PCT Filed: May 15, 2013
(86) PCT No.: PCT/EP2013/060081

§ 371 Date: Nov. 13, 2014

(30) Foreign Application Priority Data
May 22, 2012 (DE) 10 2012 208 550.5

(51) Int. Cl. F03D 9/00; F03D 1/00

(52) U.S. Cl. CPC F03D 9/002; F03D 1/001
USPC 290/55; 29/596

(57) ABSTRACT

The invention concerns a generator for a gearless wind power installation, with a stator and a runner, whereby the stator and/or the runner have windings made of aluminum.

### BACKGROUND

1. Technical Field

This invention relates to a generator for a gearless wind power installation and a wind power installation with such a generator and a method for erecting a wind power installation.

2. Description of the Related Art

Gearless wind power installations are generally well-known. They have an aerodynamic rotor which, driven by the wind, directly drives an electrodynamic rotor directly driven by the wind, which is referred to as a runner to avoid confusion. The aerodynamic rotor and the runner are rigidly coupled and turn at the same speed. Since the aerodynamic rotor in modern wind power installations turns relatively slowly, for example in the range of 5 to 25 rpm, the runner also turns correspondingly slowly. For this reason, a generator in a modern gearless wind power installation is a large diameter multi-pole generator.

The disadvantage of this type of large generator is that it is difficult to handle because of its size, and particularly difficult to assemble. Transporting it can be problematic because of its size. They have large-scale copper windings, which also makes them very heavy. Supporting structures must be designed in a correspondingly complex manner.

Copper, however, is unrivaled as a material for electrical wiring in a generator due to its good electrical properties. Notably, there has been no other material available in sufficient quantities which offers copper's high level of conductivity and which is also relatively unproblematic to work. It also retains its properties over the entire temperature range found naturally on the earth where wind power installations may be erected or located. Its high conductivity means it is possible to construct correspondingly small generators in suitable places.

Nowadays, it is notably transport that limits the size of generators. It is particularly the diameter of a generator, i.e., an external diameter of the generator of 5 m that is a critical size for the transport of generators. Accordingly, the air gap diameter, i.e., the diameter of the generator in the area of the air gap, is correspondingly small. The air gap is located between the stator and the runner and its diameter is around twice the thickness of the stator—in the case of an internal runner—or twice the thickness of the rotor—in the case of an external runner type—smaller than the overall diameter of the generator. The air gap diameter determines the efficiency and electrical performance of the generator quite significantly. In other words, the largest possible air gap diameter should be sought. Accordingly, an external stator or an external rotor needs to be designed to be as thin as possible to allow the air gap diameter in specified external diameters of around 5 m to be as large as possible.

It is possible to extend the generator in the axial direction, i.e., to make it longer. By doing this, the nominal capacity of the generator can be effectively increased using the same air gap diameter. However, extending it in this way in the axial direction leads to problems with stability. In particular, if the part of the generator outside the air gap is to be designed to be as thin as possible, this type of generator with a longer design can quickly reach its stability limits. In addition, the windings are very heavy but basically cannot contribute to mechanical stability.

### BRIEF SUMMARY

One or more embodiments are directed to generators for gearless wind power installations that have improved performance, stability and/or weight. At the very least, an alternative design to previous solutions is provided.

In accordance with one embodiment of the invention, a generator for a gearless wind energy installation features a stator and a runner. The stator and/or the runner have aluminum windings.

In accordance with one embodiment of the invention, it was specifically recognized that aluminum is indeed a poorer conductor than copper, but on the basis of its comparably low weight may however be advantageous to the overall design of the generator.

The poorer conductivity of aluminum in comparison to copper must first be countered with a larger cross-section area of the relevant windings, which initially results in a higher volume requirement. In contrast, however, aluminum is significantly lighter than copper, so that the generator is actually lighter overall in spite of this. This lower weight may also put less demand on the requirements of the support structures, i.e., the mechanical structure of the wind power installation overall, and also the mechanical structure of the generator. This in turn may save weight and possibly volume.

Using windings made of aluminum means specifically that the windings are made of aluminum and exhibit natural insulating properties, in particular insulating varnish or similar. However, in principle there are also aluminum alloys which come into consideration, which for example may influence some of the characteristics of aluminum, such as its workability, in particular its flexibility. It is crucial that aluminum is available as a lightweight electrical conductor and forms a large part of each winding. It is not a question of a few additives or impurities, which barely change the basic conductivity or the basic specific weight of aluminum. Aluminum should be a decisive factor for the weight and conductivity of the windings.

It is preferably suggested that the generator should be an external runner type. This means the stator, namely the stationery part, is internal and the runner turns around it. The first advantage of this is that the diameter can be increased in principle because in principle the runner does not need to be as thick as the stator. Accordingly, the runner requires less space between the air gap and a maximum outer diameter, so that the air gap diameter can be increased for a given external diameter.

It must also be considered that stators are frequently designed with laminated cores, which are provided with windings on the air gap side. Such a laminated stator core can, in the case of an external runner type, be enlarged in an inward direction as much as desired, i.e., towards the central axis of the generator, and designed with cooling channels and the like. Here in the case of an external runner type, there is ample space for the stator, so that designing an external type generator creates plenty of space for the stator de facto.

The runner, at least if it is separately excited, is constructed completely differently, namely it generally consists of runner poles fully equipped with windings, which are linked on the side away from the air gap to a supporting structure, namely a cylinder Jacket. If the generator is of the external runner type, the pole shoe bodies extend from the air gap outwards, in a slightly starred formation outwards. In other words, the available space increases from the air gap to the supporting structure. The placement of windings for the separate excitation is therefore facilitated, because more space is available if an external runner type is used.

Therefore, the use of aluminum with the additional space for the external type of runner combines to positively effect at least for the excitation windings of the runner.

The aluminum windings can therefore be designed for the runner in an advantageous manner. The additional space described for supporting the stator can likewise also be used to allow for aluminum windings in the stator. The stator may, for example, provide additional winding space for this by an increase in the radial direction. The air gap diameter is unaffected by this. Even a possible increase in the magnetic resistance in the stator may be permissible compared to the magnetic resistance of the air gap. If necessary, a lighter runner, which is lighter than a copper runner due to the use of light aluminum, may allow a more rigid structure for the runner to be achieved, which may allow the air gap to be reduced, thereby allowing the magnetic resistance to be reduced.

Preferably, a generator with an air gap diameter of over 4.3 m is proposed. This demonstrates that one or more embodiments of the present invention concerns generators of large gearless wind power installations. Embodiments of the present invention do not merely claim the invention of a generator with aluminum windings. Rather, one or more embodiments are directed to a large generator, such as a generator for a gearless wind power installation, with aluminum windings. The use of aluminum windings for a large generator in a modern gearless wind power installation has thus far been irrelevant in professional circles because instead, attempts were made to optimize generators in other ways. These include attempts to create the smallest possible volume, which in turn excluded the use of aluminum as winding material for the specialist. Thus, the use of aluminum windings in large gearless generators for wind power installations was contrary to the goals of the prior art.

In accordance with a further embodiment, it is proposed that an external runner type is used as the type of generator, whereby the runner consists of several runner segments in the circumferential direction, in particular from 2, 3 or 4 runner segments. In particular, the runner segments are ready to be assembled on-site when the wind power installation is being constructed. Preferably, however, the stator will be designed integrally, notably with a continuous winding for every phase.

By using aluminum as winding material, runners, at least those in a separately excited synchronous generator, weigh less and therefore favor a structure in which the rotor is assembled. Even by using two essentially semicircular runner segments, a generator with a diameter of more than 5 m can be produced, without exceeding the critical transport size of 5 m. When using a one-piece stator of such an external runner type, the external diameter of the stator, which corresponds roughly to the air gap diameter, is roughly the critical transport size, notably 5 m. The runner is then assembled on site when road transport is no longer required. In this case, the precise size of the generator, namely, the runner segment only represents a minor problem. Now the weight of the element is much more important. However, the weight can be reduced by the use of aluminum. In order to realize the same absolute conductivity with aluminum instead of copper, about 50% greater winding volume is required, however this still weighs only half of the corresponding copper winding. In spite of the increase in volume, the use of aluminum allows the weight to be drastically reduced. By using a segmented runner, there is no more upper limit for volume, the runner can be made larger and this leads—paradoxically—to a lighter weight runner because now aluminum can be used.

It is accordingly advantageous that the generator is designed as a separately excited synchronous generator and the runner has excitation windings made of aluminum. This is as described particularly advantageous for an external runner type, in particular for a segmented external runner type, but may also be beneficial for an internal runner.

Preferably, the generator will have a nominal capacity of at least 1 MW, in particular at least 2 MW. This embodiment also emphasizes that the invention particularly relates to a generator for a gearless wind power installation in the megawatt class. Such generators are now being optimized, and until now, aluminum has not been considered as a material for windings. However, it was recognized that the use of aluminum can be advantageous and does not have to be limiting or disadvantageous compared to copper. Even if there are already generators with aluminum windings, which may have been developed in particular countries at particular times due to a shortage of raw materials, this gives no indication or suggestion of equipping a generator in a megawatt class gearless wind power installation with aluminum windings.

Preferably, the generator is designed as a ring generator. A ring generator is a form of generator in which the magnetically effective area is essentially arranged concentrically on a ring area around the rotation axis of the generator. In particular, the magnetically effective area, namely of the runner and of the stator, is only arranged in the radial external quarter of the generator.

A preferred embodiment suggests that the generator is designed as a slow-running generator or as a multi-pole generator with at least 48, at least 72, especially at least 192 stator poles. Additionally or alternatively, it is favorable to make the generator a six-phase generator.

Such a generator should be designed particularly for use in modern wind power installations. Being multi-polar means it allows the runner to operate at very slow speed, which adapts to a slowly rotating aerodynamic rotor due to the absence of gears and is especially good to use with this. It should be noted that having 48, 72, 192 or more stator windings incurs a correspondingly high cost for windings. In particular, if such a winding is continuous in places, switching to aluminum windings is a huge development step. The stator bodies which already need to be wound, namely the laminated cores, are to be adapted to the modified space requirement. Likewise, the manageability of aluminum for such windings must be relearned, and if necessary, aluminum alloys must be designed to facilitate such modified windings. A modified stator also needs to be reconsidered from the point of view of its fixture in the wind power installation, in particular to an appropriate stator support. In doing this, both mechanical and electrical connection points can be changed, and it opens up the possibility of adapting the entire support structure to the reduced weight. In particular, the use of a wind power installation in which the generator is not positioned on a machine base or its own foundation, basically leads to the requirement for a complete rework of the nacelle design of the wind power installation in the event of a fundamental generator modification, or has other far-reaching consequences.

A wind power installation is likewise proposed that uses a generator like the one described in accordance with at least one of the above embodiments.

A method for constructing such a wind power installation is also being proposed. Preferably, the assembly includes a wind power installation with a generator with separable outer runners. For this purpose, it is proposed first to mount the generator stator on a tower, namely on a nacelle or on the first part of the nacelle.

The runner is then assembled on-site or at the same time in the vicinity of the site, such as in a “mini-factory”. The runner assembled in this way is then mounted on the tower with the pre-assembled stator, so that the assembled runner and stator basically form the generator.

The invention will now be explained in further detail with reference to exemplary embodiments.

### BRIEF DESCRIPTION OF THE SEVERAL VIEWS OF THE DRAWINGS

FIG. 1 shows a wind power installation in a perspective view.

FIG. 2 shows an internal runner type generator in a lateral sectional view.

FIG. 3 shows an external runner type generator in a lateral sectional view.

FIG. 4 schematically shows two pole shoes of a runner of an internal runner type generator.

FIG. 5 schematically shows two pole shoes of a runner of an external runner type generator.

### DETAILED DESCRIPTION

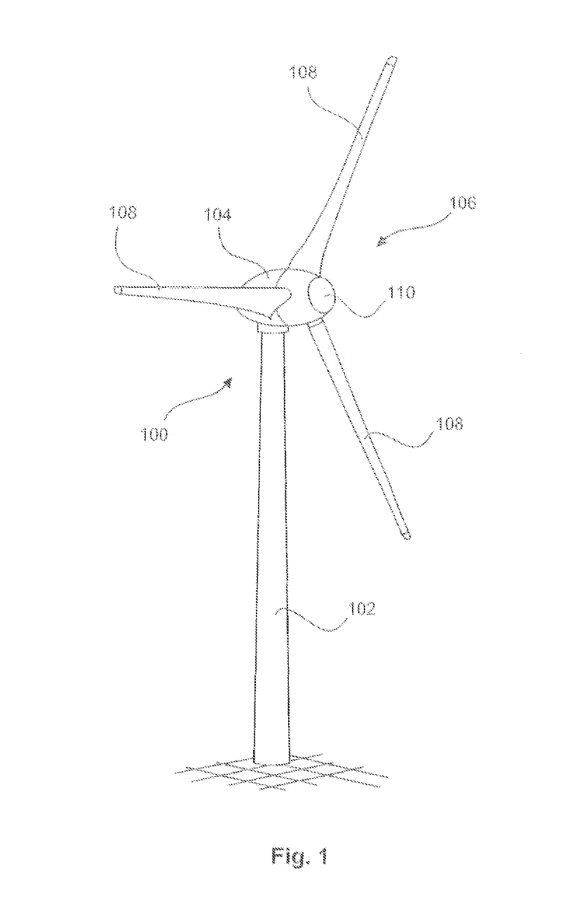

FIG. 1 shows a wind power installation 100 with a tower 102 and a nacelle 104. A rotor 106 with three rotor blades 108 and a spinner 110 is located on the nacelle 104. The rotor 106 is set in operation by the wind in a rotating movement and thereby drives a generator in the nacelle 104.

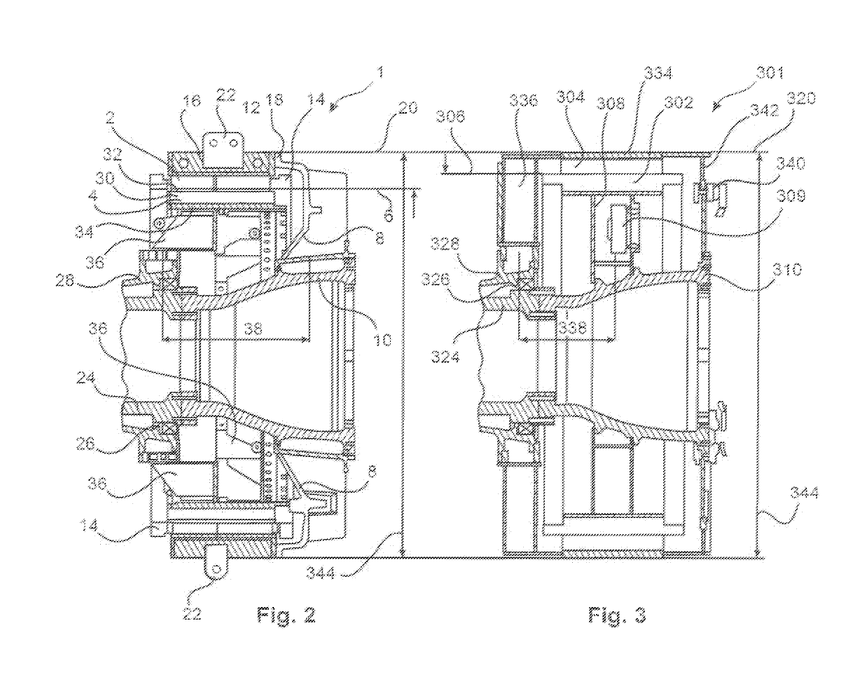

FIG. 2 shows an internal runner type generator 1 and with it an external stator 2 and an internal runner 4. Between the stator 2 and the runner 4 lies the air gap 6. The stator 2 is supported by a stator bell 8 on a stator support 10. The stator 2 has laminated cores 12, which include the windings of which the winding heads 14 are shown. The winding heads 14 basically show the winding wires which come out of one stator slot and go into the next stator slot. The laminated cores 12 of the stator 2 are attached to a bearing ring 16, which can also be seen as part of the stator 2. By means of this bearing ring 16, the stator 2 is mounted on one stator flange 18 of the stator bell 8. Above this, the stator bell 8 supports the stator 2. Furthermore, the stator bell 8 can allow for cooling fans, which are arranged in the stator bell 8. These allow air for cooling to be forced through air gap 6 in order to cool the air gap area.

FIG. 2 also shows the external circumference 20 of the generator 1. Only handling tabs 22 protrude from it, which is however unproblematic as these are not present over the entire circumference.

A partially shown axle journal 24 is attached to the stator support 10. The runner 2 is mounted on the axle journal 24 via a runner mounting 26. For this purpose, the runner 2 is attached to a hub section 28, which is also connected to the rotor blades of the aerodynamic rotor, so that the rotor blades moved by the wind can turn the runner 4 above this hub section 28.

The runner 4 also has pole shoe bodies with excitation windings 30. Part of the pole shoe 32 on the excitation windings 30 can be seen from the air gap 6. On the sides away from the air gap 6, i.e., on the inner side, the pole shoe 32 with the excitation winder, which it supports, is attached to a runner support ring 34, which is attached around it by means of a runner support 36 fixed to the hub section 28. The runner support ring 34 is basically a cylinder jacket shaped, continuous, solid section. The runner support 36 has numerous braces.

It can be seen in FIG. 2 that the radial spread of the runner 4, namely from the runner support ring 34 to the air gap 6 is significantly narrower than the radial spread of the stator 2, namely from the air gap 6 to the external circumference 20.

Furthermore, a load length 38 is drawn in, which approximately describes the axial spread of the stator bell 8 to the end of stator 2 turned away from it, namely the winding head 14. In this structure, this axial load length is relatively long and shows how far the stator 2 must support itself beyond the stator bell 8. Due to the internal runner 4, there is no more support or mounting space for the stator 2 on the side turned away from the stator bell 8.

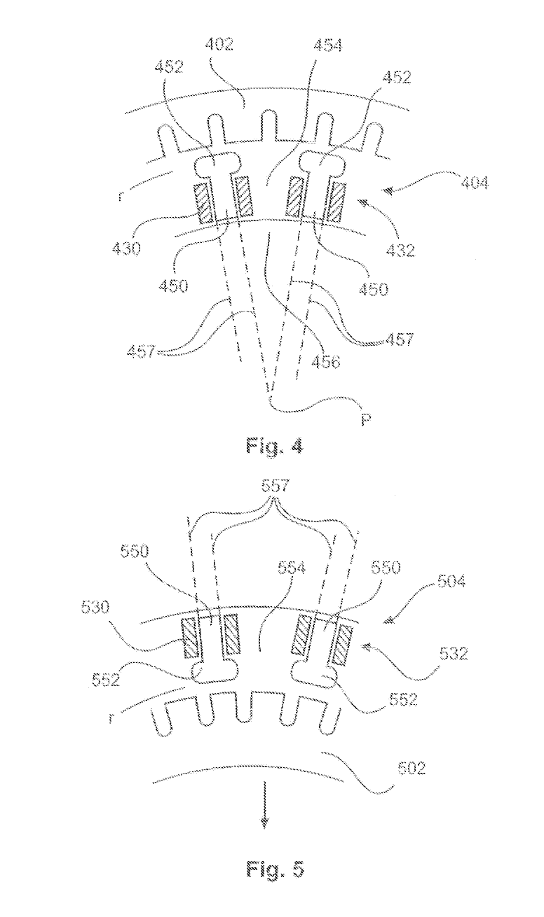

The generator 301 in FIG. 3 is of the external runner type. Accordingly, the stator 302 is internal and the runner 304 is external. The stator 302 is supported by a central stator support structure 308 on the stator mounting 310. A fan 309 is drawn into the stator support structure 308 for cooling. The stator 302 is therefore mounted centrally, which can significantly increase stability. It can also be cooled from the inside by the fan 309, which is only representative of additional fans. The stator 302 is accessible from inside this structure.

The runner 304 has an external runner type support ring 334, which is attached to a runner support 336 and is supported by this on the hub section 328, which is mounted in turn on the runner bearing 326 on an axle journal 324.

Due to the basically reversed arrangement of the stator 302 and runner 304, there is an air gap 306 with a larger diameter than the air gap 6 in FIG. 2 of the internal runner type generator 1.

FIG. 3 also shows a favorable arrangement of a brake 340, which can be attached to the runner 304 by a brake disc 342 attached to the runner 304 if necessary. In this case, the tightened break 340 results in a stable condition, in which the runner 304 is held in the axial direction on 2 sides, namely on one side in the end over the bearing 326 and on the other side over the attached brake 340.

In FIG. 3, an axial load length 338 is also drawn in, which also has an average distance from the stator support structure 308 to the runner support 336. Here, the distance between the 2 support structures of the stator 302 and the runner 304 is significantly reduced compared to the axial load length 38 shown in the internal runner type generator in FIG. 2. The axial load length 38 in FIG. 2 also provides an average distance between the two support structures for the stator 2 on the one side and the runner 4 on the side. The smaller such an axial load length 38 or 338 is, the greater the stability that can be achieved, in particular also a tipping stability between the stator and the runner.

The external diameter 344 of the external circumference 320 is identical in both of the generators shown in FIGS. 2 and 3. The external circumference 20 of the generator 1 in FIG. 2 therefore also shows the external diameter 344. In spite of this same external diameter 344, in the structure in FIG. 3, which shows the external runner type generator 301, it is possible to achieve a larger air gap diameter for the air gap 306 compared to the air gap 6 in FIG. 2.

In FIG. 4 an external stator 402 and an internal runner 404 are shown. FIG. 4 shows very schematically two pole shoe bodies 432 with one shaft 450 and a pole shoe 452. Between the two pole shoes 432, in particular between the two shafts 450, there is a winding space 454. The cables for excitation windings 430 are to be laid inside it. Since every pole shoe body 432 supports excitation windings 430, the winding space 454 must basically take cables from two excitation windings 430.

Based on the fact that the pole shoe bodies 432 in FIG. 4 belong to an internal runner, the shafts 450 of the pole shoes 452 end together, whereby the winding space 454 becomes smaller. This could lead to problems in accommodating the excitation windings 430.

In FIG. 5 an internal stator 502 and an external runner type 504 are shown. FIG. 5 shows a similar schematic diagram of two pole shoe bodies 532, but however one external runner type. Here, it can be seen that the shafts 550 extend away from the pole shoes 552, so that a winding space 554 expands and therefore creates a lot of space for cabling for the excitation windings 530.

FIG. 5, particularly in comparison to FIG. 4, illustrates that only by using an external runner type can a significantly larger winding space 554 be created, which favors the use of aluminum as a material for the windings. Using the illustrated increase in the absolute winding space 554 compared to the absolute winding space 454, using an external runner type, as illustrated in FIG. 5, also improves handling and in particular assembly.

Moreover, in accordance with FIG. 4, the adjoining connection space 456 attached to the shafts 450 also narrows. For illustration purposes, the shafts 450 are also drawn with dashes. It is particularly problematic how the pole shoe bodies and thereby the pole of the runner altogether are basically provided and installed individually. The space basically available in the connection space 456 can therefore be difficult to use.

On the contrary, a corresponding connection space 556 is larger in accordance with FIG. 5 due to the arrangement as an external runner type.

A solution is therefore found which suggests the use of aluminum in generators. What initially appears to be an antiquated workaround, which a specialist with access to copper would reject for the construction of a modern generator in a wind power installation, appears to be an advantageous solution. The use of aluminum in generators may be less advantageous if an internal runner is used. Internal runner generators are structurally limited by their design. However, in external runner type generators, the generators are specified differently or constructed fundamentally differently, which allows the use of aluminum and is even advantageous.

It should also be pointed out that when calculating a runner, this must normally be based on a predetermined air gap radius r. Based on this air gap radius, the internal runner is inwardly limited, because the pole shafts, the extension of which is shown by the guide lines 457 in FIG. 4, would otherwise meet at point P shown in FIG. 4. This limits the radial dimensions of an internal runner. If an external runner type is used, these limitations do not exist because the shafts diverge outwardly, as illustrated by the guide lines 557, therefore do not meet and therefore are not limited in their radial dimensions. In this way, an external runner type is particularly well suited for use with aluminum windings that require more winding space.

The use of aluminum is proposed for the stator or the runner or both. In the construction of an external runner type, a larger air gap diameter is possible, which allows and favors the use of aluminum.

Further advantages are that the cost of aluminum is lower and sometimes there is better access to the material, at least in a construction of the external runner type. The use of copper is therefore avoided, at least in the stator or the runner. Although a higher volume efficiency can be achieved in principle with copper, this raises the price, both in direct costs for the copper material and possibly in terms of cost for the construction and the necessary support structure for the heavy copper.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A generator comprising:
a stator; and
a runner wherein at least one of the stator and the runner have windings made of aluminum,
wherein the generator is a gearless generator for a wind power installation.

2. The generator according to claim 1, wherein the runner is external to the stator.

3. The generator according to claim 2, comprising an air gap diameter between the stator and the runner of more than 4.3 m.

4. The generator according to claim 2, wherein the runner includes a plurality of runner segments arranged in a circumferential direction, stator formed as a single piece with a continuous winding.

5. The generator according to claim 1, wherein the generator is designed as a separately excited synchronous generator and the runner has excitation windings made of aluminum.

6. The generator according to claim 1, wherein the generator is configured to generate at least 500 kW.

7. The generator according to claim 1, wherein the configured to rotate between 5 to 25 rotations per minute, has at least 48 stator poles, and is a 6-phase generator.

8. A wind power installation comprising:
a gearless generator comprising:
a gearless generator comprising:
a runner, wherein at least one of the stator and the runner have windings made of aluminum.

9. A method for erecting a wind power installation the method comprising:
mounting a stator of a generator on a tower of the wind power installation to be erected, wherein the stator has aluminum windings;
assembling runners for the generator on-site and within a vicinity of the tower and
mounting the assembled runners on the tower, thereby forming in combination with the mounted stator the generator.

10. The method according to claim 9, wherein the generator is configured to rotate between 5 to 25 rotations per minute.

11. The method according to claim 9, mounting the assembled runners on the tower comprises mounting the assembled runners on the tower outward of the stator.

12. The method according to claim 11, wherein mounting the assembled runners on the tower comprises mounting the assembled runners a distance of more than 4.3 m from the stator.

13. The generator according to claim 4, wherein runner includes four runner segments.
